(19) United States
(12) Patent Application Publication
(10) Pub. No.: US 2006/0106631 A1
(43) Pub. Date: May 18, 2006

(54) Social preference and occupation tag system

(76) Inventor: Mario S. Waller, Aurora, CO (US)

Correspondence Address: Mario S. Waller, 3963 S. Sable Way, Aurora, CO, 80014, US

(21) Appl. No.: 10/991,902

(22) Filed: Nov. 18, 2004

(51) Int. Cl. G06Q 99/00

(52) U.S. Cl. 705/1

(57) ABSTRACT

A system and method to create and define a universally identifiable icon which may be employed by a individual as a way to visually display one's interest in having a specific social relationship, whether it be romantic or platonic in nature, by means of displaying one's common interest, participation, affiliation or occupation. When the system and method is displayed by an individual, it allows the individual to attract other individuals who have an exclusive understanding of the system and method. The system and method allows an individual to initiate a public random interaction between other individuals for the purpose a social interaction, public camaraderie or a romantic relationship. More specifically the defined universally identifiable icons may define a individual's social interaction preferences, social status, marital status, sexual orientation, personal interests, and/or occupation. Each icon is created by a method using a cascading array of shape-color-shape-color-combinations signifying a uniquely defined combination of interests and preferences. An user who displays an icon created by this system and method would do so in either an obvious or discreet manner on their person, their personal property or through electronic or digital transmission. The icon which an individual displays represents their particular desire to have a social relationship and their particular interest or interests.

### BACKGROUND OF THE INVENTION

The present invention relates generally to interest and preference matching often employed in dating service concepts. Specifically, unlike many interest and preference matching systems currently employed, the presented system and method is not dependent on membership of participants; it is not dependent on plurality of participation for user interaction within a predefined gathering or group, it is not dependent on electronic dissemination by computer software, it is not dependent on scoring of input supplied by users; it does not require third-party evaluation to determine matching of participating users. Users recognizing and understanding the defined icon system's significance can randomly approach as well as give license to be approached by individuals in a undefined public environment who display an interest or interests that each individual has in common or is attracted to for the purpose of initiating a social relationship between individuals.

### DESCRIPTION OF PRIOR ART

U.S. Pat. No. 5,920,845 issued to Risemberg; Rafael (82 Charles St. #2R, New York, N.Y. 10014) on Apr. 4, 1997 describes a means and method for use at a date matching event to determine, in a discreet manner, the date preferences of a plurality of participants. The method includes gathering the plurality of participants at the date matching event, and assigning a unique identification code to each participant. The identification code is worn or otherwise displayed in plain sight, being readily observable by a plurality of the other participants. Each applicant may next, if time permits, be provided a temporal period to introduce themselves to the other participants, which is followed by a temporal interval for applicants to interact. After an interval for interaction, the date preferences of each participant are discreetly collected and analyzed to determine all occurring mutual matches. The mutual match results are then delivered to the participants, wherein matched participants may then meet to discuss the arrangements for their date.

U.S. Pat. No. 4,173,016 issued to Dickson; Carlisle H. (2805 N. Humbolt, Milwaukee, Wis. 53212) on Jan. 4, 1973 describes an interpersonal-introduction signaling system includes a receiving and transmitting transceiver having a relatively short range response and of such size as to permit convenient carrying by a person. A code system defines a plurality of categories, each of which has a particularly identifiable characteristic. Each person carrying a similar receiving and transmitting transceiver can select a particular code to send and a particular code to accept, such that designated information is transmitted and/or received. When accepting a signal or information, a different signal is sent by the receiver to indicate the acceptance to the person transmitting. The transceiver includes an indicator to alert the receiving person and indicate the necessity of transmitting a response. Thus, the encoding permits the several persons involved to define the different categories of persons having selected unique characteristics for contact.

U.S. Pat. No. 4,847,890 issued to Solomon; Merrill (Washington, DC); Kimball; John (Germantown, Md.) on Aug. 10, 1987 describes a method and apparatus for establishing telephone communications between service subscribers and responding callers through a central system while preserving confidentiality and mutual anonymity of the subscribers and callers. Incoming calls from callers intended for subscribers identified by coded entries, are transferred by the system controller and a digital switch either to a message recording facility or directly to the subscriber. If the subscriber is unavailable, a message can be left by the caller, but does not need to include the telephone number of the caller. The subscriber then is able to call the caller, through the central system controller, without breaching anonymity of either the caller or the subscriber.

U.S. Pat. No. 3,992,787 issued to Lynch; John Patrick (1934 Portland Ave., St. Paul, Minn. 55104) on Dec. 15, 1975 describes an astrological comparison apparatus having movable indicators and wheels containing astrological data for simple and rapid comparison of the astrological criteria associated with individuals.

U.S. Pat. No. 5,086,394 issued to Shapira; Shmuel (225 S. Reeves Dr., #5, Beverly Hills, Calif. 90212) on Mar. 29, 1990 describes an introduction system for participating users, includes for each user a personal device that is subject to activation by remote paging. Each user, also has a memory device that contains personal data defining the user by personal characteristics such as traits and interests.

U.S. Pat. No. 4,711,632 issued to Detrick; Jeffrey C. (P.O. Box 3155, Shawnee Mission, Kans. 66203) on Jul. 30, 1986 employs a simple, easy-to-use astrological/educational tool is provided which allows a user to readily obtain information regarding those individuals or groups who are compatible or incompatible with the user, in accordance with astrological principles. In preferred forms, the tool of the invention includes a central circular section bearing circularly arrayed astrological sign indicia on both faces thereof, together with a compatibility wheel and an incompatibility wheel respectively rotationally coupled to the central section and oriented adjacent the separate faces of the latter. The user can readily ascertain the signs of both compatible and incompatible individuals or groups by simple manipulation of the wheels.

U.S. Pat. No. 4,348,740 issued to White; Edward A. (5780 Echo Canyon Cir., Phoenix, Ariz. 85018) on Jun. 13, 1980 employs a method and portable processor for storing and comparing sets of personal data relating to personal preferences and personality. First and second portable processing units each include a processor, a memory, an input device, a display device, and a connector. The owner of a portable processor can enter personal data via the input device of the portable processor in response to a questionnaire. The owner of that portable processor may then meet another person having a similar or identical portable processor storing that person's personal data. The two persons can interconnect the two portable processors by means of the connectors. Each portable processor transmits its data to the other and compares its stored data with corresponding data received from the other portable processor. Stored algorithms in each portable processor operate on the compared data to compute a score representing the degree of personal compatibility of the two persons and display the score by means of the respective display devices.

### BRIEF SUMMARY OF THE INVENTION

A number of interest and preference matching systems have been developed over the years which deal with matching similar interests and preferences of individuals together using prearranged plurality of participation through membership, electronic dissemination, computer compilations, or third party evaluation and intervention of participation input.

While such matchmaking systems are similar in scope they are limited to predetermined parameters disseminated through computer compilations or third-party intervention. Furthermore, previous interest matching systems do not easily define individuals looking for non-romantic friendship, platonic companionship or simply camaraderie with individuals of similar interests.

Accordingly, what we have developed is a universally identifiable system and method to publicly display one's interests and preferences in a way that openly invites social interaction during random public encounters unconstrained by the parameters of a pre-defined gathering or group environment; done without electronic devices; without implementation of computer software and compilations; or without third-party dissemination, evaluation, or intervention.

Objects of the present invention method are, therefore, to create a universally identifiable system for use by an individual to publicly display one's interests and preferences in a undefined random public environment through personal adornment or digital transmission;
a method to create a universally identifiable system for use by an individual to non-verbally convey one's interests and preferences in a undefined random public environment;
a method to create a universally identifiable system for use by an individual to personally distribute or transmit one's interests and preferences by telephony or electronic transmission;
a method to create a universally identifiable system which enables users to invite random social interaction in a undefined random public environment;
a method to create a universally identifiable system which enables users to pursue random social interaction in a undefined random public environment;
a method to enable users to display personal interests and preferences for the purpose of public camaraderie with exclusivity in a undefined random public environment;

The above listed objects along with the description of the invention and figure drawings presented herein clearly understate the advantages and original applications of the Social Preference and Occupation Tag System. It should be recognized that the description and figure drawings are illustrative only and variations are contemplated as being part of the invention, limited only by the scope of the appended claims.

### BRIEF DESCRIPTION OF THE SEVERAL VIEWS OF THE DRAWINGS

FIG. 1 shows how the Social Preference and Occupation Tag System method creates and defines each icon using the cascading method of the shape-color-shape-color creating a distinct and specific interests or preferences within a universally identifiable icon.

FIG. 2-shows an example of how the system's Outer Shape can define the type of social relationship and sexual orientation in building the primary component of the Social Preference and Occupation Tag System icons.

FIG. 3-shows an example of how the system code Outer Shape's Color would be assigned to define an individual's Primary Interest Category. Each distinct Outer Shape Color would carry through to the secondary and sub-interest level to further define a specific Social Preference and Occupation Tag System icon.

FIG. 4-shows an example of how the system code's Inner Shape would be assigned to indicate a Secondary Interest Category within a Primary Interest Category further defining each Social Preference and Occupation Tag System icon.

FIG. 5-shows an example of how the system code Inside Shape's Color would be assigned to further define a specific Sub-interest within a Secondary Interest Category further defining each Social Preference and Occupation Tag System icon.

FIG. 6-shows an example of how the integration of the previously illustrated steps in FIG. 1 through FIG. 5 to create and define a specific Social Preference and Occupation Tag System icon.

FIG. 7-shows an example of how the system code icons could be displayed for use by a individual to interact in public.

### DETAILED DESCRIPTION OF THE INVENTION

Preferred embodiments of the current invention are now described with reference to the figures. Certain embodiments discussed herein relate to known display and distribution methods. However, the current invention may be used in any application allowing an individual's display of interest and/or preference with respect to pre-defined icons. Accordingly, the current invention is not limited to the display and distribution methods described herein.

This invention is a method and system which can create a universally identifiable icon for use by and individual to attract and initiate social interaction in a random public environment. These icons would convey in a non-verbal means an individual's interest, affiliation, occupation, marital status, sexual orientation, or any other interest and/or preference which would attract others with similar interest and/or preferences. The method and system which creates these universally identifiable icons would require a familiar and consistent appearance yet have the ability to be as uniquely different the individual displaying a particular icon. The invention employs a very basic system of cascading shapes and colors oriented in an array which can be quickly and easily identified and deciphered.

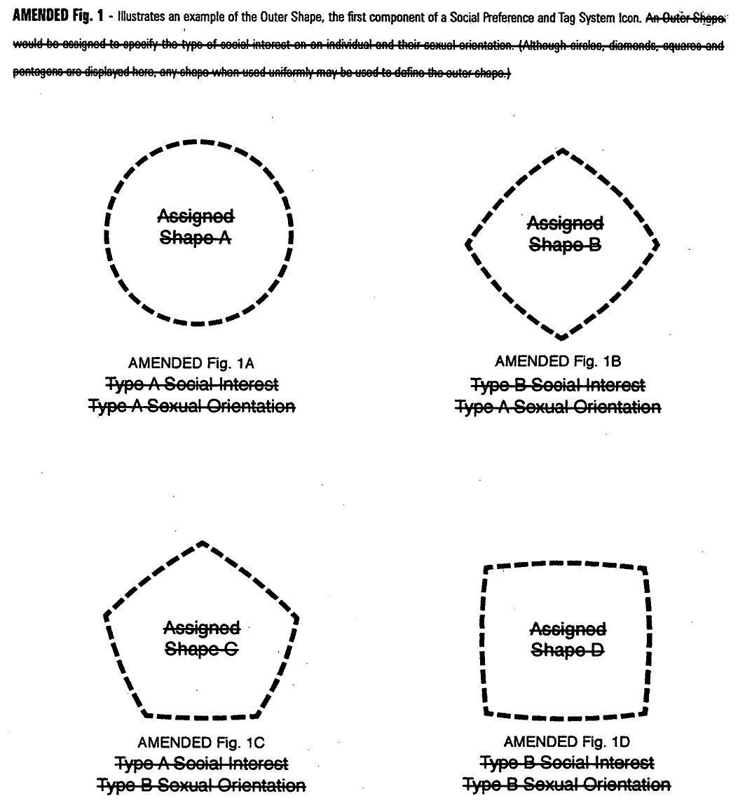

Referring to FIG. 1, depicts the Outer Shape, the first component of a Social Interest and Tag System Icon. An Outer Shape would be assigned to specify the type of social interest on an individual and their sexual orientation. (Although circles, diamonds, squares and pentagons are displayed here, any shape when used uniformly may be used to define the Outer Shape.) The Outer Shape has a two-fold representation indicating the type of social relationship you wish to attract as well as the sexual orientation of individual you wish to appeal to, i.e. a circle may represent someone who is looking for a romantic relationship with a heterosexual individual; a diamond Outer Shape may represent someone who is only interested in plutonic friendship or camaraderie. The Outer Shape remains consistent for each category it is assigned to. FIG. 1A and FIG. 1B depicts how the shape can represent an individual's different preference for a social interest with the someone with the same sexual orientation A. FIG. 1C and FIG. 1D depicts how the shape can represent an individual's different preference for a social interest with someone of the same sexual orientation B.

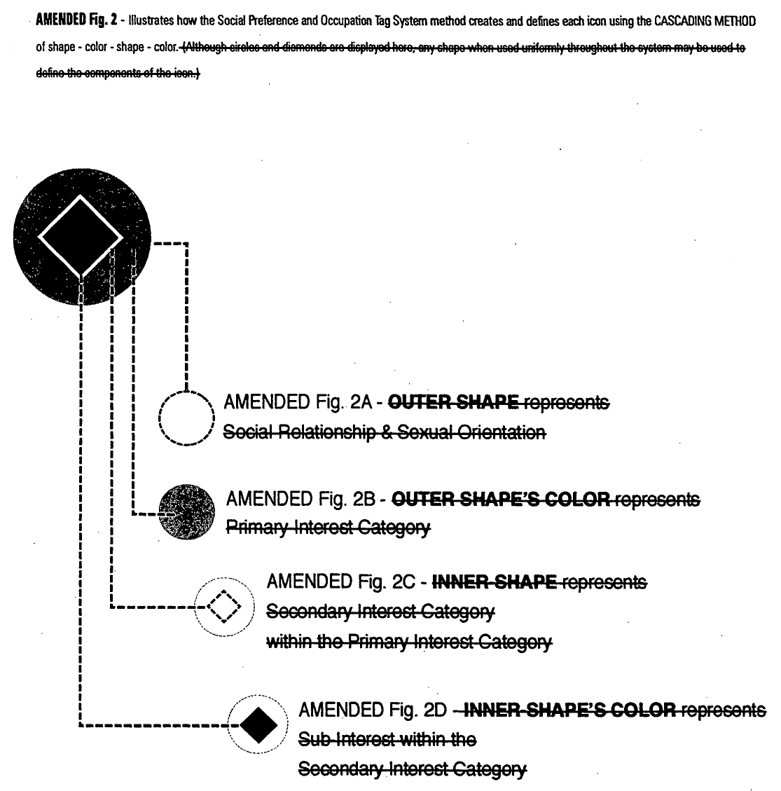

Referring to FIG. 2, illustrates each component which comprises a Social Preference and Occupation Tag System Icon and how the CASCADING METHOD of shape-color-shape-color is sequenced to complete an Icon within the System. (Although circles and diamonds are displayed here, any shape when used uniformly throughout the system may be used to define the components of the icon). FIG. 2A again depicts the Outer Shape described in FIG. 1, the first component of the multi-faceted icon. The Outer Shape remains consistent for each category it is assigned to. FIG. 2B depicts the Outer Shape's Color, the second component of the multi-faceted icon. The Outer Shape's Color represent the Primary Interest Category of the individual, i.e. the color blue may represent an individual interested in sports while the color orange may represent and individual interested in hobbies. The Outer Shape's Color remains consistent for the Primary Interest it represents and is the foundation of the Secondary and Sub-interest Categories depicted in FIG. 2C and FIG. 2D. FIG. 2C depicts the Inner-Shape, the third component of the multi-faceted icon. The Inner-Shape represents a Secondary Interest Category within the Primary Interest Category depicted in FIG. 2B. This is a more specific interest within the Primary Interest selected in FIG. 2B, i.e. if the Primary Interest Category selected in FIG. 2B is sports, the Secondary Interest Category may be team-oriented spots and would be defined by a specific Inner-Shape. Each Secondary Interest Category would be represented by a different Inner-Shape, remain consistent for the Secondary Interest Category it represents and is dependent on the Outer Shape's Color which encloses it. FIG. 2D depicts the Inner-Shape's Color, the fourth component of the multifaceted Icon. The Inner-Shape's Color represents a Sub-interest Category within the Secondary Interest Category selected in FIG. 2C. This is more defined interest within the Secondary Interest Category, i.e. if team sports is the Secondary Interest Category selected in FIG. 2C. the Inner-Shape's Color may represent the team sport of football in FIG. 2D. Each Sub-Interest is represented by a specific color and is dependent on the Inner-Shape which encloses it and the Outer Shape's Color which encloses the Inner-Shape.

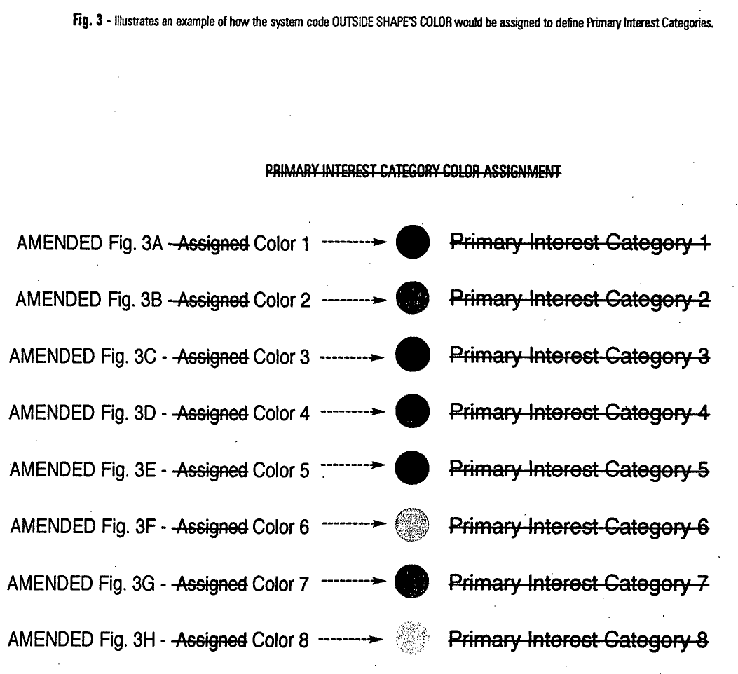

Referring to FIG. 3, illustrates an example of how the system code Outer Shape's Color would be assigned to define Primary Interest Categories. FIG. 3 depicts how a specific assigned color in FIG. 3A through 3H represents a different Primary Interest Category depicted in FIG. 2B. within the Social Preference and Occupation Tag System. Each Secondary Interest Category and Sub-Interest is defined based upon the color assigned to the Primary Interest Category.

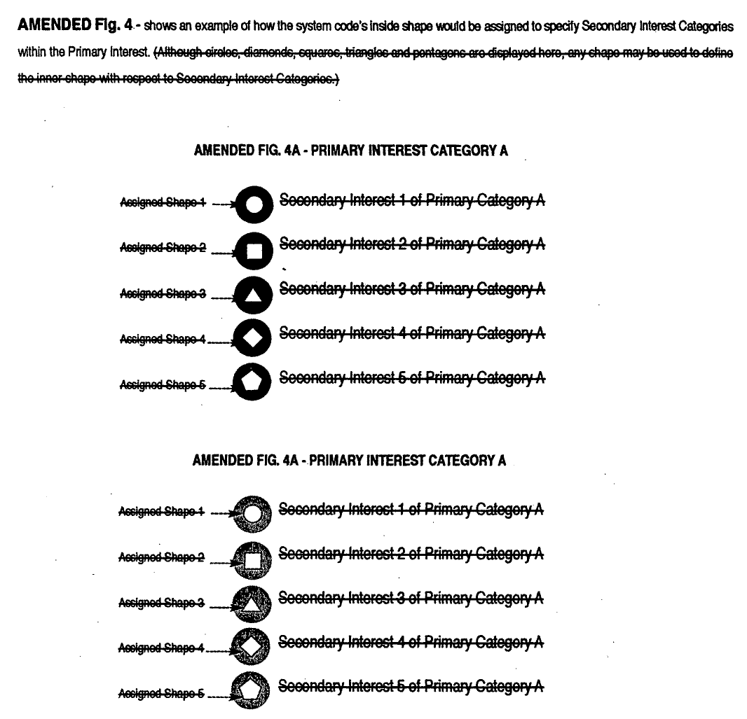

Referring to FIG. 4, depicts how the system code's Inner-Shape would be assigned to specify Secondary Interest Categories within the Primary Interest. (Although circles, diamonds, squares, triangles and pentagons are displayed here, any shape may be used to define the inner shape with respect to Secondary Interest Categories.). A specific shape is assigned to a Secondary Interest Category within a Primary Interest Category. The shape remains consistent for each assigned Secondary Interest Category and is dependent upon the Outer Shape's Color. Since the same shape can be used within different Primary Interest Categories, the Inner-Shape can only define a Secondary Interest based on the color of the Outer Shape. In FIG. 4A, a square Inner-Shape within Primary Interest A represents a different Secondary Interest than, in FIG. 4B, a square Inner-Shape with in Primary Interest B. The Secondary Interests included within each Primary Interest Category is limited only to the number of distinctive shapes assigned in the Secondary Category within a Primary Interest Category.

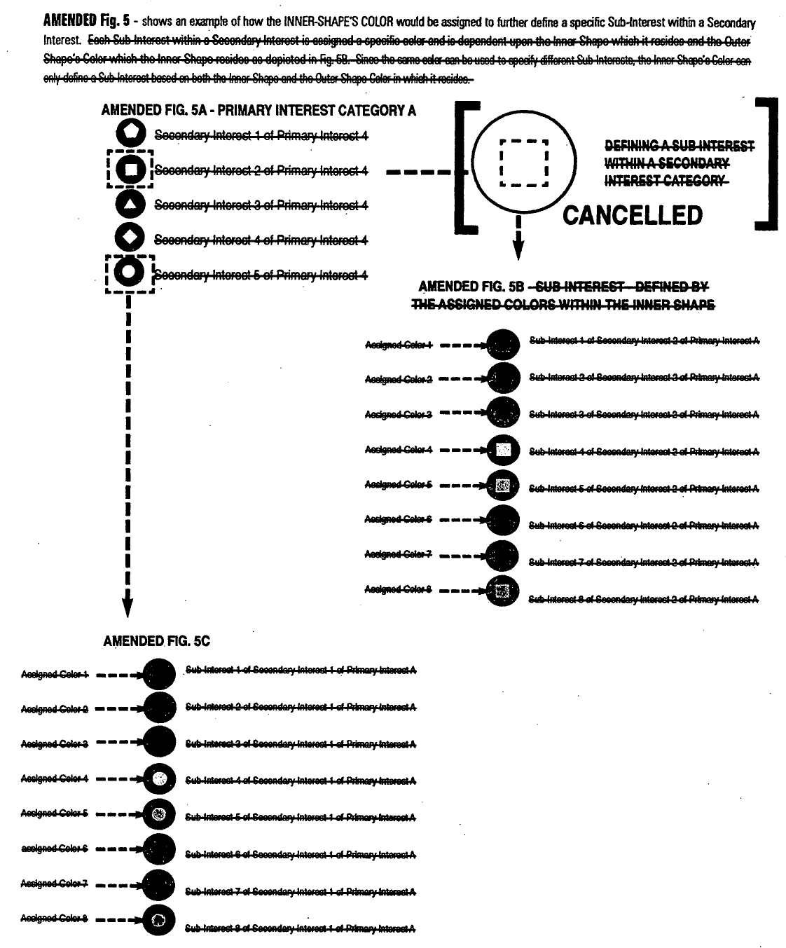

Referring to FIG. 5, depicts how the INNER SHAPE'S COLOR would be assigned to further define a specific Sub-Interest within a Secondary Interest. FIG. 5A illustrates that the color resides within both the Inner-Shape and the Primary Interest. Within each Secondary Interest Inner-Shape is a specifically defined color assigned to represent a Sub-Interest within a Secondary Interest. FIG. 5A uses a square to represent the Secondary Interest 2 within Primary Interest Category A. Each Sub-Interest within a Secondary Interest is assigned a specific color and is dependent upon the Inner-Shape which it resides and the Outer Shape's Color which the Inner-Shape resides as depicted in FIG. 5B. FIG. 5B illustrates Sub-Interest 1 by specifying an Assigned Color 1 within a square Inner-Shape which represents Secondary Interest 2 within Primary Interest A. Since the same color can be used to specify different Sub-Interests, the Inner-Shape's Color can only define a Sub-Interest based on both the Inner-Shape and the Outer Shape Color in which it resides. In FIG. 5B, Assigned Color 1 within Secondary Interest 2 and Primary Interest A represents a different Sub-interest than, in FIG. 5C, Assigned Color 1 within Secondary Interest 1 and Primary Interest A because they color resides within a different Inner Shape. The number of Sub-Interests included within each Secondary Interest Category is limited only to the number of distinctive colors assigned in the Sub-Interests and the shapes assigned in the Secondary Category.

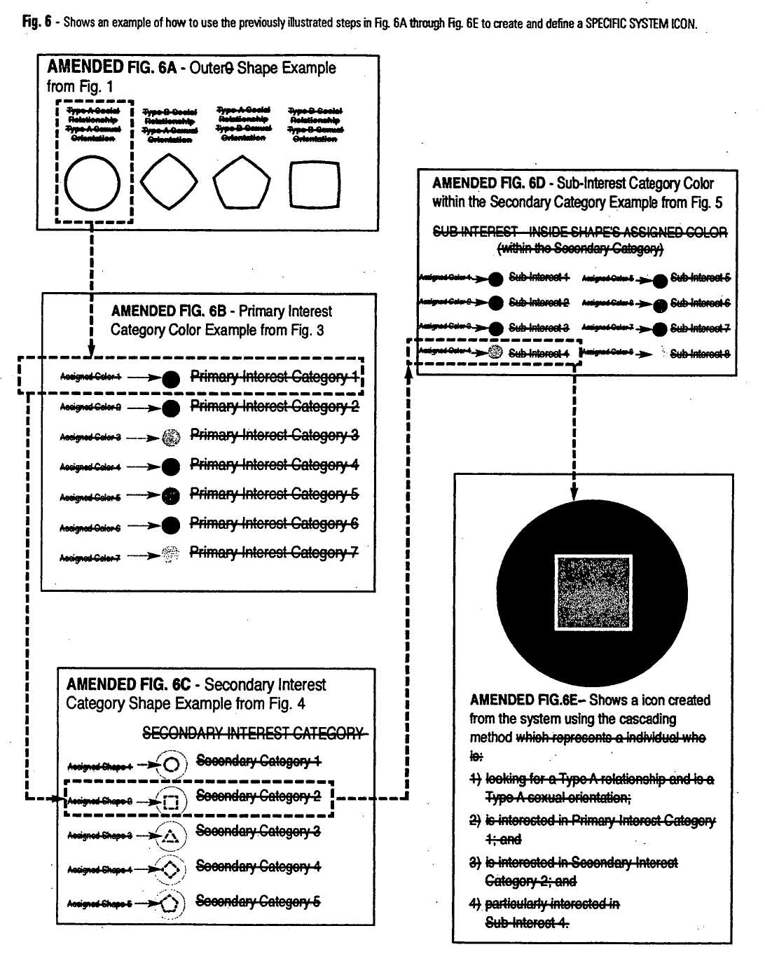

Referring to FIG. 6, Shows an example of how to use the previously illustrated steps in FIGS. 1 through 5 to create and define a SPECIFIC SYSTEM ICON. FIG. 6A illustrates the selection of an Outer Shape which signifies an individual (X) who is themself, and looking for someone who interested in a “Type A Social Relationship” with a “Type A Sexual Orientation”; and who, in FIG. 6B, has an interest in “Primary Interest Category 1”; and who, in FIG. 6C, has a interest in “Secondary Interest Category 2” within “Primary interest Category 1”; and who, in FIG. 6D, is interested in “Sub-Interest 4” within “Secondary Interest Category 2”. In FIG. 6E is depicted the “Social Preference and Occupation Tag Icon” that is derived for the system and method herein and represents individual (X)'s own specific interests and the type of individual (X) may be interested in meeting.

Once the Social Preference and Occupation Tag System Icons have been assigned the Outer Shape, Outer Shape's Color, Inner-Shape, and Inner-Shape's Color each Icon will be view in it whole and specifically define in a categorized diagram or chart organized first by the Outer Shape's Color which would be defined as the Primary Interest. The diagram or chart allows for easy reference to the specific definition of each Social Preference and Occupation Tag System Icon

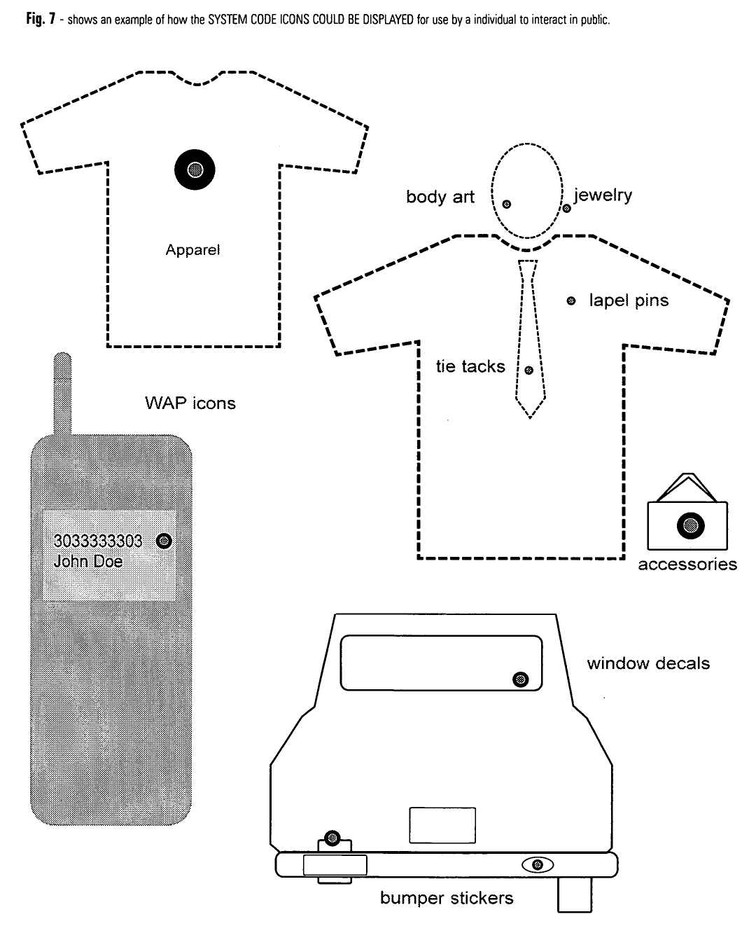

Now that we've illustrated how the Social Preference and Occupation Tag System derives each unique Interest Icon in FIG. 1 through FIG. 6, the actual function and use of the method and system of each uniquely defined Icon by a user is quite a simple one. Referring to FIG. 7, shows an example of how the system code icons could be displayed for use by a user to interact in public. Once an individual has selected an Icon for display it may be placed on any publicly viewable surface, apparel, personal accessory, personal property, and directly to one's person to be noticed by other individuals in a random public setting. We need only to set a few parameters for use, when displaying a Social Preference and Occupation Tag System Icon you are willing to have a spontaneous interaction with other individuals displaying Social Preference and Occupation Tag System Icon or have a spontaneous interaction with other individuals who have an understanding of or and, interest in, what the Icon signifies. Unlike other interest and preference matching systems currently employed, the Social Preference and Occupation Tag System and method is not dependent on membership of participants; it is not dependent on plurality of participation for user interaction within a predefined gathering or group, it is not dependent on electronic dissemination by computer software, it is not dependent on scoring of input supplied by users; it does not require third-party evaluation to determine matching of participating users. Users recognizing and understanding the defined icon system's significance can randomly approach as well as give license to be approached by individuals in a undefined public environment who display an interest or interests that each individual has in common or is attracted to for the purpose of initiating a social relationship between individuals.

While herein have been described the present invention, those skilled in the art will recognize that other and further modifications may be made without departing from the present invention, and it is intended to claim all modifications and variations as fall within the scope of the describe system and method the invention embodies.

I claim:

1. A method for creating a universally identifiable icon system defined by a cascading array of shape, color, shape, color symbols, to convey a individual's personal interests through public display and comprised by:
1(a). an outer shape specifically assigned to define a user's level of social availability;
1(b). an inner-color within the outside shape specifically assigned to define a user's primary interest;
1(c). an inner-shape within the outside shape specifically assigned to define a user's secondary interest within a user's primary interest;
1(d). an inner-color within the inner-shape specifically assigned to further define a user's specific sub-interest within the secondary interest;
1(e). a chart system for categorizing each created icon into a their defined meaning.

2. The method of displaying of icons created by the universally identifiable icon system of claim 1 as an invitation of random social interaction in a undefined random public environment.

3. The method of displaying an icon created by the universally identifiable icon system of claim 1 in a undefined random public environment upon any apparel for human consumption for public display.

4. The method of displaying an icon created by the universally identifiable icon system of claim 1 in a plurality of participation.

5. Displaying an icon created by the universally identifiable icon system of claim 1 upon any jewelry accessory for human consumption for public display.

6. The method of distribution of icons created by the universally identifiable icon system of claim 1 by digital communication through internet communication.
